(19) United States
(12) Patent Application Publication
(10) Pub. No.: US 2026/0197434 A1
(43) Pub. Date: Jul. 9, 2026

(54) FRAMEWORK FOR TESTING AND CHARACTERIZING 3D CAMERAS IN WAREHOUSE LOGISTICS

(71) Applicant: Dexterity, Inc., Redwood City, CA (US)

(72) Inventors: Arjun Dhawan, San Francisco, CA (US); Zhouwen Sun, San Mateo, CA (US); Sidharth Tadeparti, Stanford, CA (US)

(21) Appl. No.: 19/277,259

(22) Filed: Jul. 22, 2025

Related U.S. Application Data
(60) Provisional application No. 63/674,712, filed on Jul. 23, 2024.

(51) Int. Cl. H04N 17/00; G06T 1/00; G06T 7/80

(52) U.S. Cl. CPC H04N 17/002; G06T 1/0014; G06T 7/85; G06T 2207/10024; G06T 2207/10028

(57) ABSTRACT

Techniques are disclosed to test and characterize three-dimensional cameras for use with robotic systems to perform warehouse logistics tasks. Image data generated by a camera is received via a communication interface. A first set of image data is used to perform camera sensor testing to generate a set of base capabilities for the camera. Camera characterization processing is performed with respect to the camera, based at least in part on the set of base capabilities. One or more of the following are determined based at least in part on the camera characterization processing: one or more optimal camera settings; an optimal camera placement; and an optimal image processing algorithm parameter.

### CROSS REFERENCE TO OTHER APPLICATIONS

This application claims priority to U.S. Provisional Ser. No. 63/674,712 entitled FRAMEWORK FOR TESTING AND CHARACTERIZING 3D CAMERAS IN WAREHOUSE LOGISTICS filed Jul. 23, 2024, which is incorporated herein by reference for all purposes.

### BACKGROUND OF THE INVENTION

In logistics automation, 3D cameras capable of capturing both color images (e.g., right, green, blue or “RGB”) and depth data (D) are becoming increasingly useful as vision inputs to automation systems. RGB-D cameras can be categorized based on the technology they use to obtain depth: e.g., Stereo, Time-of-Flight (TOF), Frequency Modulated Continuous Wave LiDAR and other LiDAR, and Structured Light. Each depth capture technology has its own advantages and disadvantages, and within each category, vendors offer cameras with varying capabilities.

Evaluating the depth component of the output from 3D cameras in the context of a specific application is crucial to the performance of the system. However, unlike RGB cameras, no standard method for evaluating RGB-D cameras has been established. Metrics such as depth accuracy, spatial precision, temporal precision, and fill rate can quantitatively evaluate RGB-D cameras, but these metrics do not directly translate to the camera's performance in specific applications. This lack of standardization makes it difficult to debug issues in algorithm development, as it is unclear whether problems arise from the scene, camera settings, or the algorithm itself.

### BRIEF DESCRIPTION OF THE DRAWINGS

Various embodiments of the invention are disclosed in the following detailed description and the accompanying drawings.

FIG. 1A illustrates an embodiment of a robotic system to perform tasks in a warehouse or other logistics context.

FIG. 1B illustrates an embodiment of a system to test and characterize a camera to use in a robotic system to perform tasks in a warehouse or other logistics context.

FIG. 2 illustrates an embodiment of a process to test and characterize a camera to use in a robotic system to perform tasks in a warehouse or other logistics context.

FIG. 3 illustrates an example of a technique to assess a camera's performance in an environment in which multipath interference may occur.

FIG. 4A is a flow diagram illustrating an embodiment of a process to segment image data and fit a box representation to a 3D set of points associated with a box-shaped object in a workspace.

FIG. 4B is a flow diagram illustrating an embodiment of a process to test the performance of a given camera as a source of image data to be used to generate a box representation to a 3D set of points associated with a box-shaped object in a workspace.

FIG. 5 is a flow diagram illustrating an embodiment of a process to determine optimal settings for a camera for use in connection with a robotic system to perform tasks in a warehouse or other logistics context.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Techniques are disclosed to evaluating and characterize 3D cameras that capture both color images (RGB) and depth data (D), such as may be used by an autonomous robotic system to perceive and handle objects, e.g., in a warehouse or other logistics context, such as truck or other vehicle or container loading and unloading, palletization/depalletization, singulation/sortation, kitting, etc. In various embodiments, a system and framework as disclosed herein offers both quantitative benchmarks for camera selection and characterization methods to specify how these cameras should be configured and used. This framework addresses the need for a standardized method to evaluate the performance of RGB-D cameras in specific warehouse logistics applications, thereby improving system performance and facilitating algorithm development.

In various embodiments, a testing and characterization framework as disclosed herein includes one or more of the following:
Quantitative Benchmarks: Establishing standardized metrics for evaluating RGB-D cameras, including but not limited to depth accuracy, spatial precision, temporal precision, fill rate, angle of incidence resolution, dimensioning accuracy, and plane fitting.
Characterization Methods: Providing guidelines for characterizing 3D cameras in specific warehouse logistics applications. These characterization methods include testing procedures to determine the optimal camera settings and placements for different scenarios.
Performance Evaluation: Developing a standardized approach to assess the performance of 3D cameras in the context of warehouse logistics, ensuring the selected camera meets the specific requirements of the application given above quantitative benchmarks and characterizations.

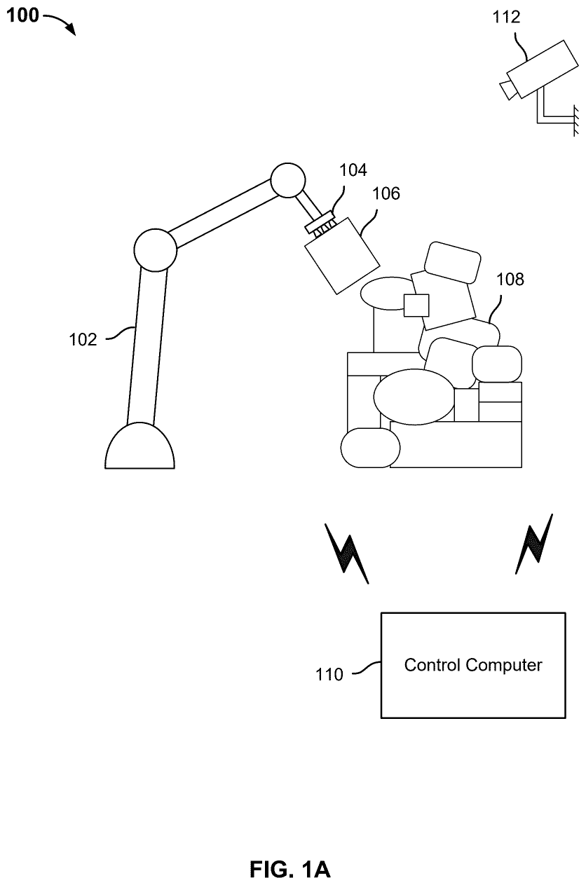

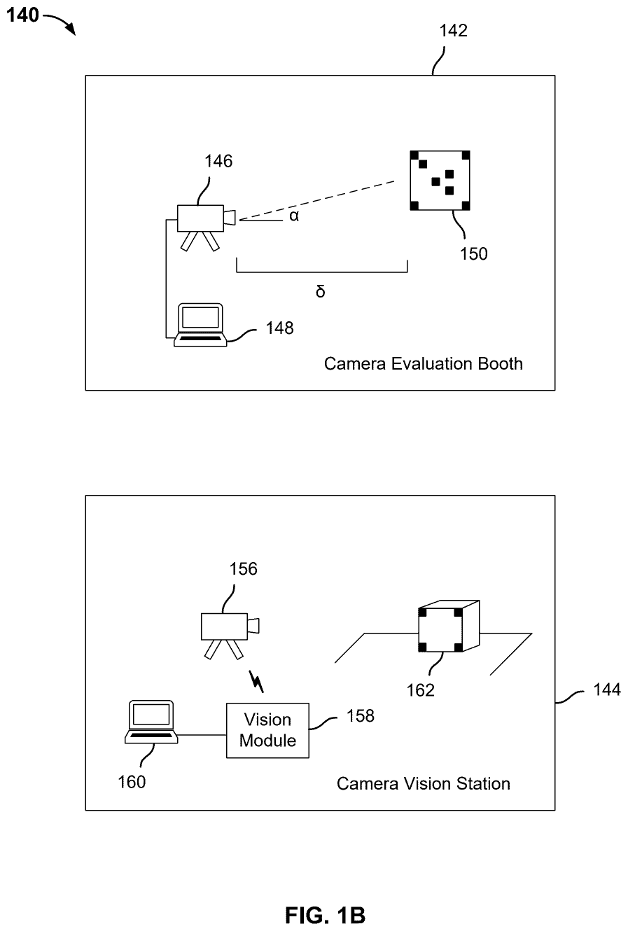

FIG. 1A illustrates an embodiment of a robotic system to perform tasks in a warehouse or other logistics context. In the example shown, robotic system 100 includes a robotic arm 102 with a suction-type end effector 104 at its distal end. As shown, robotic arm 102 and end effector 104 have been used to grasp and lift box 106 from a pile of arbitrary items 108, including in this example boxes and other less regularly shaped items. In a logistics context, items 108 may include boxes, large and small articles not in packaging, articles in a polybag, such as a mailing bag, or other non-rigid packaging, etc.

Referring further to FIG. 1A, robotic system 100 further includes a control computer 110 in wireless communication with robotic arm 102 and end effector 104, either directly or via a robot controller provided and configured to operate robotic arm 102 and end effector 104, e.g., in response to commands received from control computer 110. The robotic system 100 further includes a camera 112, e.g., a three-dimensional (3D) camera that provides two-dimensional image pixels (e.g., red, blue, green or RGB pixels) as well as a point cloud or other depth information. The latter information may be generated by measuring the “time of flight” (TOF) of an infrared or other signal emitted from the camera 112 and reflected back to a receiver comprising camera 112.

In various embodiments, image and depth information generated by one or more cameras, such as camera 112, is used by a control computer, such as computer 110, to generate and maintain a three-dimensional view of a workspace or at least a region of interest (ROI) within a workspace. The image data may be processed according to a Random Sample Consensus (RANSAC) or similar algorithm. The three-dimensional view may be used to control a robot, such as robotic arm 102 and end effector 104, to identify an object to be picked and placed, determine a strategy to grasp the object, and generate and implement a plan to move the object to a destination location and place the object at the destination location, e.g., in an orientation as indicated in the plan.

In various embodiments, techniques disclosed herein may be used to evaluate, characterize, and configure an RGB-D or other 3D camera for use in a robotic system, such as camera 112 of robotic system 100.

FIG. 1B illustrates an embodiment of a system to test and characterize a camera to use in a robotic system to perform tasks in a warehouse or other logistics context. In the example shown, camera testing and characterization system 140 includes a camera evaluation booth 142 and camera vision station 144.

In various embodiments, a camera evaluation station, such as camera evaluation booth 142, may comprise a physical space that is isolated or isolatable from external influences on camera performance, except as introduced in a controlled manner. In the example shown, camera evaluation booth 142 includes camera 146, i.e., the camera that is being evaluated, connected to a laptop or other computer 148. The camera 146 is used to generate images of a target, such as target 150 in the example shown, vary one or more variables according to a test plan or procedure, such as one or more of the examples set out in the section below under the heading “Camera Sensor Testing”. For example, the distance from the camera to the target; the orientation and height of placement of the target; and the angle(s) of offset of the target from the longitudinal centerline of the camera may be varied. In some embodiments, lighting, temperature, dust, smoke, vapor, or other environmental conditions may be simulated and/or varied in testing. In the example shown, target 150 has fiducial markings, in this example on the four corners, to serve as a reference for use in certain tests (e.g., see the example test plan below).

In the example shown, camera vision station 144 includes the camera 156 being tested along with a computer vision module 158, such as may be used by a control computer to generate a three-dimensional view of a workspace, and a test operator computer 160 configured to receive and process information produced by the vision module 158 based on image data from camera 156. In some embodiments, the vision module 158 may comprise a software module running on computer 160.

In various embodiments, camera 156 is used to generate images of a three-dimensional target, such as box 162 in the example shown, that is of known (or separately reliably measured) size (e.g., dimensions), orientation, and placement. The object 162 may have fiducial markings, as shown, and/or active or passive markers, such as OptiTrack™ or other retroreflective markers. In various embodiments, information determined by processing images generated by camera 156 may be compared to a base truth (e.g., known position and orientation of box 162), e.g., to determine how accurate a view of a scene may be generated by system using camera 156 and/or to iterate through different camera settings and/or image processing algorithm parameters to determine how best to use an instance of camera 156 in a robotic system.

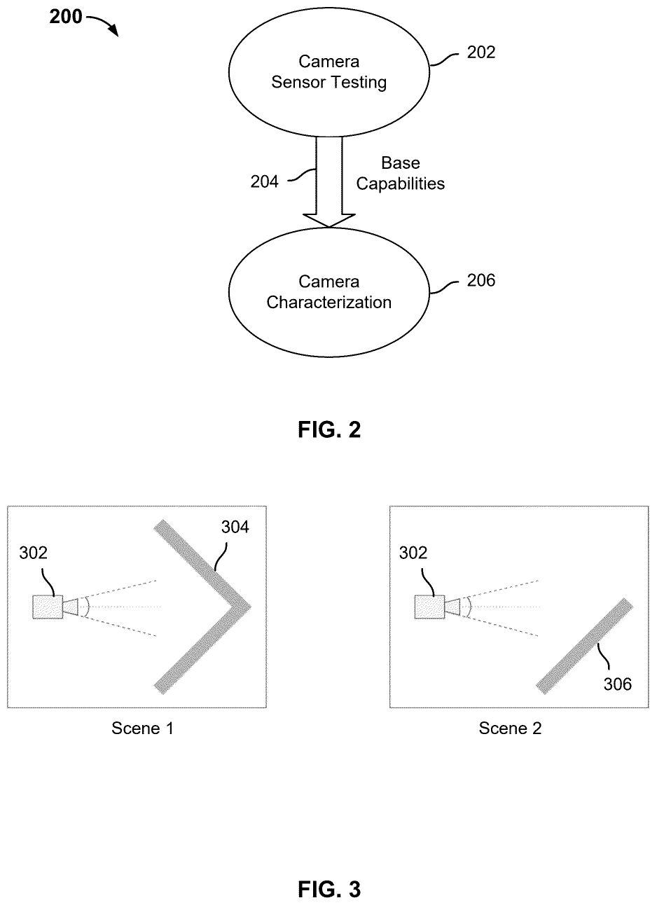

FIG. 2 illustrates an embodiment of a process to test and characterize a camera to use in a robotic system to perform tasks in a warehouse or other logistics context. In the example shown, process 200 includes a first phase or state 202 in which camera sensor testing is performed. The camera sensor testing produces a set of base capabilities 204, which may then be used in a camera characterization phase or state 206.

In various embodiments, a testing and characterization system and framework as disclosed herein implement a test plan. The test plan provides a concrete repeatable process for evaluating color cameras with depth perception capability (RGB-D). At a high level, the evaluation is split into Camera Sensor Tests and Camera Characterizations. The Camera Sensor Tests are targeted at producing quantitative metrics which can be used to benchmark and compare cameras. The Camera Characterizations will be used to evaluate performance of the cameras in settings relevant to specific logistics-related robotic applications, provide ideal camera usage parameters, and provide data for future benchmarking tests.

In various embodiments, one or more of the following goals are achieved:
1. Benchmark camera performance
2. Provide base level camera performance metrics
3. Give confidence to end users on camera capabilities given the test results and camera characterizations.

In various embodiments, testing pass/fail criteria expressed below as a variable, such as “X” (indicating a numerical value) or “x %” or the like are populated for a given instance and application of the test plan detailed below using values determined as being appropriate for a given context and environment, such as the light, humidity, and other environmental factors; the extent to which the workspace is cluttered, crowded, constrained, full of obstacles, etc.; whether other actors (robots, humans) will be operating in the space, and other factors such as the value, fragility, or other attributes of items to be handled. For example, tighter tolerances/higher fidelity may be required in contexts in which valuable goods may be damaged or human workers injured.

In some cases, pass/fail thresholds/criteria may be determined empirically. For example, the tests may be run on a very expensive and highly precise camera, in the intended environment, and test criteria may be set to ensure that other (e.g., lower cost) cameras that are tested achieve at least sufficiently similar results. Pass/fail criteria may be updated over time, e.g., based on observed experience.

The following example test plan illustrates aspects of a system and framework to test and characterize a 3D camera for use in a warehouse logistics robotic application, in various embodiments.

Camera Sensor Testing. In various embodiments, one or more of the following camera sensor tests are run to gather data on the base capabilities of the camera sensor. The results of these tests inform camera characterization tests. The material selection for the following tests are indicative of the most common package materials seen in warehousing applications generally or in a specific context.
1. Depth Accuracy and Noise Test
   a. Location: Camera Evaluation Booth
   b. Type of Test: Quantitative
   c. Goal: Determine how planar the depth output is at different distances from the camera in a single frame.
   d. Description: Test targets of varying materials will be placed in front of the depth camera. Depth will be measured in the Region of Interest (ROI) and the accuracy of depth will be evaluated. The target will then be placed in extreme areas of the Field of View (FOV) of the camera (Top left, top right, middle left, middle right, bottom left, bottom right) and the depth will be remeasured in the ROI.
   e. Variables:
      i. Distance of camera from target
      ii. Material of target (Cardboard, April Tag, Fake Bread, Stretched Polybag)
      iii. Location of material in camera's FOV
   f. Metrics to Measure:
      i. Mean/Median of depth measurement in ROI
      ii. Standard Deviation of depth measurement in ROI
      iii. Mean Average Deviation of depth measurement in ROI
   g. Pass Fail Criteria:
      i. x % depth error
2. Temporal Depth Accuracy and Noise Test
   a. Location: Camera Evaluation Booth
   b. Type of Test: Quantitative
   c. Goal: Determine frame to frame depth variance and optimal number of frames required for accuracy readings to stabilize
   d. Description: Test target of cardboard material is placed 1.5 m away from the camera. Depth readings across 30 frames are collected in the ROI. Initial depth distribution is then compared to the aggregated depth distribution from 1-30 frames.
e. Variables:
   i. Number of frames used for depth measurement.
   f. Metrics to Measure:
      i. Mean/Median of depth measurement in ROI
      ii. Standard Deviation of depth measurement in ROI
      iii. Mean Average Deviation of depth measurement in ROI
   g. Pass Fail Criteria:
      i. X number of frames for depth readings to stabilize or converge.
3. Depth Accuracy and Noise Test in MPI/R Environments
   a. Location: Camera Evaluation Booth
   b. Type of Test: Quantitative
   c. Goal: Determine how planar the depth output is at different distances from the camera in a single frame with multi-path reflections in the environment.
   d. Description: Reflective black curtains are placed around the camera evaluation booth. A depth camera is placed at 2.5 m above the floor. Test targets of varying materials are placed in front of the depth camera. Depth will be measured in the Region of Interest (ROI) and the accuracy of depth will be evaluated. The measurements are then compared to a nominal case.
   e. Variables:
      i. Multi-path Interference/reflections
      ii. Material of target (Cardboard, April Tag, Fake Bread, Stretched Polybag)
   f. Metrics to Measure:
      i. Mean/Median of depth measurement in ROI
      ii. Standard Deviation of depth measurement in ROI
      iii. Mean Average Deviation of depth measurement in ROI
      iv. Pixel Density in ROI
   g. Pass Fail Criteria:
      i. x % depth error given multi-path reflections
      ii. x % pixel density given multi-path reflections
4. Dimension Accuracy Test
   a. Location: Camera Evaluation Booth
   b. Type of Test: Quantitative
   c. Goal: Determine the camera's ability to discern planar distances. This directly correlates with the camera's ability to dimension boxes given the correct segmentation.
   d. Description: 2 AprilTag™ boards with distances between the tags of 32 cm and 96 cm are placed in front of the camera. The corners of the tags are identified in software and the distance between them is logged across 100 frames. The camera is moved to different distances from the test target and data collection is repeated.
   e. Variables:
      iii. Planar distance between AprilTags.
      iv. Distance of camera to target
   f. Metrics to Measure:
      v. Planar distance between tags
   g. Pass Fail Criteria:
      vi. x % error in distance measurement.
5. Angle of Incidence Dimension Accuracy Test
   e. Location: Camera Evaluation Booth
   f. Type of Test: Quantitative
   g. Goal: Determine how the camera dimensions objects at different angles of incidence.
   h. Description: To test this, an AprilTag board is placed in front of the camera and slowly tilted in intervals of 5-10 degrees. Planar distance between the edges of the april tag is measured across 10 frame captures.
   i. Variables:
      i. Angle of incidence of camera with respect to the target
   j. Metrics to Measure:
      i. Angle of Incidence
      ii. Planar distance between april tag points.
   k. Pass Fail Criteria:
      i. At x° angle of incidence of the camera to the target, the planar dimensioning error of the camera is <y%.
6. Angle of Incidence Pixel Fallout Test
   a. Location: Camera Evaluation Booth
   b. Type of Test: Quantitative
   c. Goal: Determine how the camera resolves objects at different angles of incidence.
   d. Description: To test this, various materials are placed in front of the camera and slowly tilted in intervals of 5-10 degrees. Pixel fallout or the number of black pixels in the image (as this denotes pixels without depth) is calculated as well as the total number of points in the region of interest.
   e. Variables:
      ii. Material of target (Cardboard, April Tag, Fake Bread, Stretched Polybag)
      iii. Angle of incidence of camera with respect to the target
   f. Metrics to Measure:
      iv. Angle of Incidence
      v. Pointcloud fallout
   g. Pass Fail Criteria:
      vi. (For each angle checked for each material) At x° angle of incidence of the camera to the target, the pixel fallout is less than x % of the total ROI
7. Plane Fit Test
   a. Location: Camera Vision Station
   b. Type of Test: Quantitative
   c. Goal: Determine how increased depth noise of a target at increased distances affects plane fitting.
   d. Description: A plane or box with opti-track markers is placed squarely in front of the camera. The target is moved from 0.5 to 4 m in increments of 0.5 m and camera frames are obtained at each depth. A plane is fitted to the pointcloud data and compared to the ground truth.
   e. Variables:
      i. Distance of Camera to Target
   f. Metrics to Measure:
      ii. Plane fit RANSAC alignment score
      iii. Plane fit root mean squared (RMS) distance
      iv. Point-plane noise-distance from a point in the ROI to a ground truth plane
   g. Pass Fail Criteria:
      v. Plane-fit RANSAC alignment score <x
8. Angle of Incidence Plane Fit Test
   a. Location: Camera Vision Station
   b. Type of Test: Quantitative
   c. Goal: Determine how the angle of the target plane with respect to the camera affects plane fitting
   d. Description: A target plane with OptiTrack™ markers is placed on a tilt table in front of the camera at 1.5 m. The target is tilted by 5-10° and a plane fit in the ROI is performed at each angle.
   e. Variables:
      i. Angle of incidence of the plane with respect to the camera.
   f. Metrics to Measure:
      i. Plane fit RANSAC alignment score
      ii. Plane fit root mean squared distance
      iii. Point-plane noise-distance from a point in the ROI to a ground truth plane
   g. Pass Fail Criteria:
      i. Plane-fit RANSAC alignment score <x until y°
9. Lateral Noise Test
   a. Location: Camera Evaluation Booth
   b. Type of Test: Quantitative
   c. Goal: Determine the sloping/interpolation characteristics of discrete edges seen by the depth camera.
   d. Description: A box is placed squarely in front of the camera so the sides of the box are not visible in the RGB image. An RGB-D image is captured and points are fit to the top face of the box or floor based on the mean of the points in the ROI's selected. The distribution of the points which remain are calculated.
   e. Variables:
      i. Distance of camera from target object
   f. Pass Fail Criteria:
      i. <x % of the total points in the box face are seen in the sloped points.
10. Box Distinction Test
   a. Location: Camera Evaluation Booth
   b. Type of Test: Qualitative
   c. Goal: Qualitatively evaluate how possible it is to distinguish boxes in the point cloud.
   d. Description: As a quick test of camera depth performance, we place two identical boxes close together. We take RGB-D images of the boxes and qualitatively examine how distinguished the box edges are from each other in the point cloud.
   e. Variables:
      i. Distance of the camera from the target of interest.
      ii. Type of box (small vs. large)
   f. Pass Fail Criteria:
      i. Qualitative pass fail of if boxes are distinguishable in the pointcloud
11.Camera Interference Test
   a. Location: Camera Evaluation Booth
   b. Type of Test: Quantitative
   c. Goal: Evaluate the impact of interference on the camera's performance.
   d. Description: Redo Test 1 with a cardboard material in front of the camera and introduce an 850 nm light source in the scene. Compare depth results to the nominal case
   e. Variables:
      ii. Distance of camera from test target
      iii. Presence of interfering light sources
12. Label Readability
   a. Location: Camera Vision Station
   b. Type of Test: Qualitative
   c. Goal: Evaluate readability of labels important for warehousing applications
   d. Description: Place shipping labels of interest at varying distances from the camera and capture RGB images in varying resolutions to qualitatively evaluate if it is possible to resolve the test or diagrams on the labels.
   e. Variables:
      iv. Distance of the camera from the test target
      v. Resolution of the camera
13. Camera Latency Test
   a. Location: Camera Evaluation Booth
   b. Type of Test: Quantitative
   c. Goal: To measure the latency of the camera from frame acquisition to availability on the host side.
   d. Description: To measure the camera latency, we point a camera at a monitor. We then use a script to switch the screen color and read from the camera until we register the change. The time delay between events quantifies the latency.
   e. Variables:
      i. SDK Version
   f. Pass Fail Criteria:
      ii. Camera latency is <x ms

Camera Characterization. For each of the following characterizations, the following will be elaborated upon:
1. Background of what are the primary concerns and priorities of the end user regarding the outcomes of the camera characterization test?
2. Description of characterization test to be run on the camera.
3. What Is Being Tested?

Pass/Fail criteria are not listed as this section highlights camera characterizations rather than camera tests.
1. Multi-path Interference/reflections Characterization
   a. Location: Vision Station
   b. Type of Test: Quantitative
   c. Background/Goal: In warehousing applications many environments cause multi-path interferences/reflections (MPI/R) making readings from the TOF sensor extremely noisy or inaccurate. In an ideal case, there would be no MPI/R. The goal of this test is to characterize camera performance in cases where MPI/R is evident.
   d. Description: Two scenes are captured with a depth camera. The first is a scene known to create multipath reflections (wooden wall corner). The second is a wooden wall at 45°. A plane fit is performed in both cases and the nominal scene is compared to the scene with MPI/R. The angle of incidence of the camera with respect to the wall is varied to understand how the angle impacts MPI/R occurrences. In cases where cameras do not filter out MPI/R occurrences, an OptiTrack system can be used to provide a ground truth for the wall and camera locations in 3d space.
   e. Variables:
      i. Scene With and Without MPI/R
      ii. Angle of incidence of camera with respect to the center of the target
   f. Metrics to measure:
      i. Point-plane noise-distance from a point in the ROI to a ground truth plane
      ii. Point density-average number of points per selected area (to be compared to a reference/nominal point density)
      iii. Plane fit RANSAC alignment score
      iv. Plane fit root mean squared distance
2. Plane Fitting Characterization
   a. Location: Camera Vision Station
   b. Type of Test: Quantitative
   c. Background/Goal: The most common type of package in a warehouse are boxes. To interact with boxes, using a robot, an accurate 3D representation of the boxes in the scene is generated. After image capture (RGB+Depth), ML models are first used to segment the RGB images. The masks generated from the segmentation model are then de-projected using the depth map to get 3d points. At this point box representations are fitted to the 3D points. The first step of this box-fitting algorithm is plane fitting where planes are fit to the 3D points to generate a box representation. Since the plane-fitting component of the box-fitting algorithm is most sensitive to the accuracy of point clouds generated from the depth camera, we attempt to characterize how the depth output from the camera affects plane-fitting.
   d. Description: A box of known size and shape is placed in front of the depth camera. An OptiTrack™ or other high end camera/vision system is used to determine ground truth transformation matrices for the box and camera in the OptiTrack frame. The ROI of the box plane is selected in the camera's frame based on the OptiTrack's ground truth. Plane-fitting is performed and the fit plane is compared to the ground truth. The angle of the camera with respect to the box is varied between the extreme angles identified in Test 3 & 4 and the test is repeated. The distance between the camera and target is varied between the extremes of the depth range and the test is repeated.
   e. Variables:
      i. Ransac Parameters
      ii. Angle of incidence of camera with respect to the box
      iii. Distance of the camera to the target
   f. Metrics to measure:
      i. Plane fit RANSAC alignment score
      ii. Plane fit root mean squared distance
      iii. Point-plane noise-distance from a point in the ROI to a ground truth plane
3. Adversarial Object Characterization
   a. Location: Camera Evaluation Station
   b. Type of Test: Qualitative
   c. Background/Goal: Historically, certain materials, package types, and structures are difficult to discern for our vision algorithms in the point cloud. Dark materials, lattice structures, bread materials, and reflective polybag materials are difficult to reconstruct. To get a qualitative understanding of point cloud quality we observe the point cloud with these materials in front of the cameras.
   d. Description: A fixed adversarial object is placed in front of the camera. A point cloud is captured at various heights and the quality of the pointcloud is evaluated. The lattice structure containing the adversarial objects is elevated to provide a more difficult scene to reconstruct.
   e. Variables:
      i. Elevation of Lattice Structure From Floor
      ii. Camera distance to target of interest.
   f. Metrics to measure:
      i. Point cloud consistency (1-10)
      ii. Apparent flatness of planes in the point cloud
      iii. Presence of flying pixels in image.
4. Occlusion Characterization
   a. Location: Camera Evaluation Station
   b. Type of Test: Quantitative
   c. Background/Goal: In the truck loading robotics application, occlusions to the vision hardware are fairly common. These can be categorized in two buckets: inside the camera's FOV and outside the camera's FOV. Occlusions in the camera's FOV are unavoidable in most cases, but cause issues when they affect the depth data where no occlusions are present. Depending on the material of the occlusion, reflections can occur affecting depth readings. Occlusions outside of the camera's FOV are avoidable as long as mounting of the camera is carefully analyzed. The characterization is done to understand the impact of various occlusions on the cameras depth performance.
   d. Description: The depth accuracy test is performed with occlusions outside the FOV of the camera and the results are compared to the nominal depth readings. The material is changed to characterize the camera's performance with occlusions. The depth accuracy test is again performed with occlusions encroaching on the FOV near the camera and the results are compared with the nominal depth readings.
   e. Variables:
      i. Occlusions inside and outside the FOV of the camera.
   f. Metrics to measure:
      i. Mean depth versus ground truth
      ii. Standard deviation of depth in ROI
5. Camera Design of Experiments (DOE)
   a. Location: Camera Vision Station
   b. Type of Test: Quantitative
   c. Background/Goal: In the past, camera configs/algorithm parameters typically have been a shot in the dark to determine the optimal configuration. The goal of this will be to run a design of experiments to determine the optimal camera settings for the camera and RANSAC algorithm with the monitored variable being the RMS of the plane fit compared to the ground truth.
   d. Description: A DOE will be performed with the input variables being material, RANSAC parameters, camera parameters, angle of incidence, distance of camera from target, location of target in camera FOV. The optimal RANSAC parameters and camera settings are determined from this test via regression.
   e. Variables:
      i. Material type: AprilTag board, cardboard, polybag, fake bread
      ii. RANSAC parameters
      iii. Camera parameters
      iv. Angle of incidence
      v. Distance of camera from target
      vi. Location of target in camera FOV
   f. Metrics to measure:
      i. Plane fit root mean squared (RMS) distance

In various embodiments, all or only a subset of the above tests and/or characterizations may be performed. In various embodiments, all or some of the tests and/or characterizations may be partially or fully automated, e.g., by executing test scripts or other software code to implement the steps outlined above.

In some embodiments, automation may be used to set up the test and/or characterization environment. For example, a robotic arm, rail-based robot, Cartesian coordinate or other linear robot, or other device may be used to place a camera and/or a target in a specific location and/or orientation, repeatably and without human intervention or risk of human error.

In various embodiments, once the environment has been set up, software may be used to automate operation of the camera to generate images, e.g., with different settings, different levels of light, etc. and/or to run a camera through the iterations of operations necessary to characterize the camera, such as iterating through camera settings, placement/distance to target, orientation of target, light level, obstructions, and image processing algorithm parameters. In some embodiments, results generated through such characterization may be processed to determine optimal settings/parameters, e.g., by performing regression analysis, for different camera settings, locations, orientations, environmental variables, etc.

FIG. 3 illustrates an example of a technique to assess a camera's performance in an environment in which multipath interference may occur. In various embodiments, a test environment as shown in FIG. 3 may be used to perform a characterization such as the characterization described above under the heading “Multi-path Interference/Reflections Characterization”. In the example shown, the environment includes two scenes, a first labeled “Scene 1” in which camera 302 is positioned to generate image data of a corner 304 defined by two adjacent and reflective surfaces, which would be expected to generate multipath interface, and a second labeled “Scene 2”, in which camera 302 is positioned to generate image data of a single wall 306 set at an angle to the centerline of the line of sight.

In some embodiments, a setup such as shown in FIG. 3 may be used as follows: A plane fit is performed in both cases (Scene 1 and Scene 2) and the nominal scene (Scene 2) is compared to the scene with MPI/R (Scene 1). The angle of incidence of the camera with respect to the wall is varied to understand how the angle impacts MPI/R occurrences. In cases where cameras do not filter MPI/R occurrences, an OptiTrack system can be used to provide a ground truth for the wall and camera locations in 3D space.

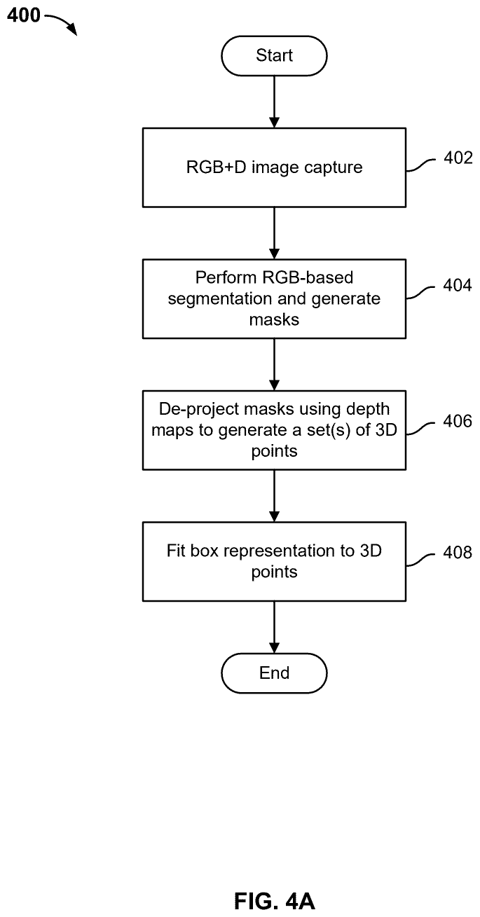

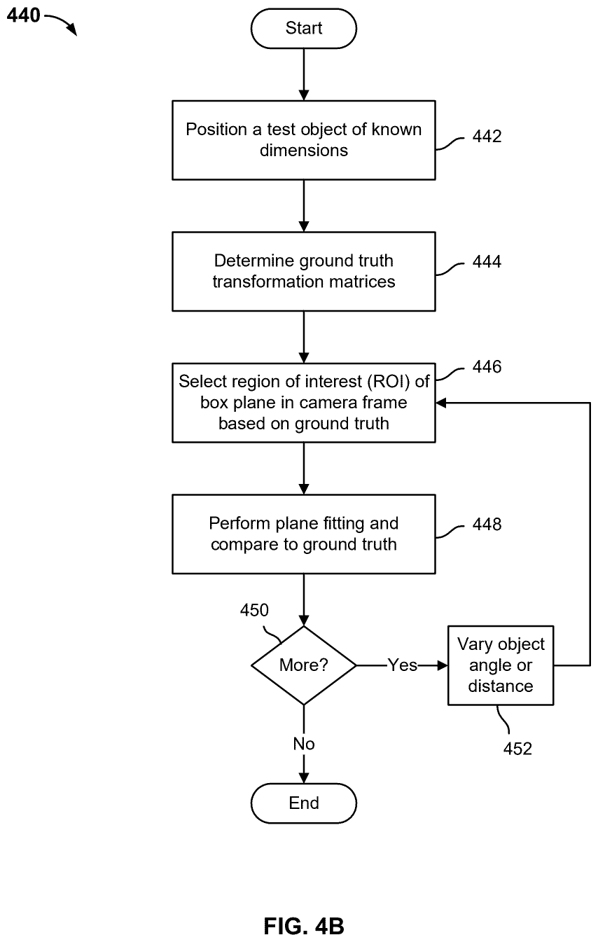

FIG. 4A is a flow diagram illustrating an embodiment of a process to segment image data and fit a box representation to a 3D set of points associated with a box-shaped object in a workspace. In various embodiments, process 400 may be implemented by a control computer, e.g., in a production environment, or a testing computer, in a testing/characterization environment, to process images from a 3D camera to generate a view of workspace. In the example shown, at 402, RGB+D data is received from one or more cameras in a workspace. At 404, RGB-based segmentation is performed, i.e., to discern the boundaries of specific boxes or other objects in the workspace, and for each object a corresponding set of masks is generated. At 406, the masks are de-projected using depth maps to generate for each object a set of 3D points. At 408, a box representation is fitted to the set of 3D points, to generate a box representation of the object.

In a production system, the box representation generated at 408 may be used to determine a plan and strategy to grasp, move, and place the object in a destination, for example.

FIG. 4B is a flow diagram illustrating an embodiment of a process to test the performance of a given camera as a source of image data to be used to generate a box representation to a 3D set of points associated with a box-shaped object in a workspace. In various embodiments, process 440 of FIG. 4B may be used to perform a plane fitting characterization of a camera under evaluation, as in the section above under the heading “Plane Fitting Characterization”. In the example shown, at 442 a test object of known dimensions is positioned, e.g., object 162 of FIG. 1B. At 444, ground truth transformation matrices are determined. For example, an OptiTrack™ or other high-end camera/vision system may be used to determine ground truth transformation matrices for the box and camera in the OptiTrack frame. At 446, the Region of Interest (ROI) is selected in the camera frame based on the ground truth determined at 444. At 448, plane fitting is performed, based on the images from the camera being characterized, and compared to the ground truth.

Subsequent iterations of the above steps 442, 444, 446, 448 are performed until all poses (e.g., object angle, distance, etc.) specified by the characterization procedure have been processed, i.e., steps 450, 452, after which the process 440 ends.

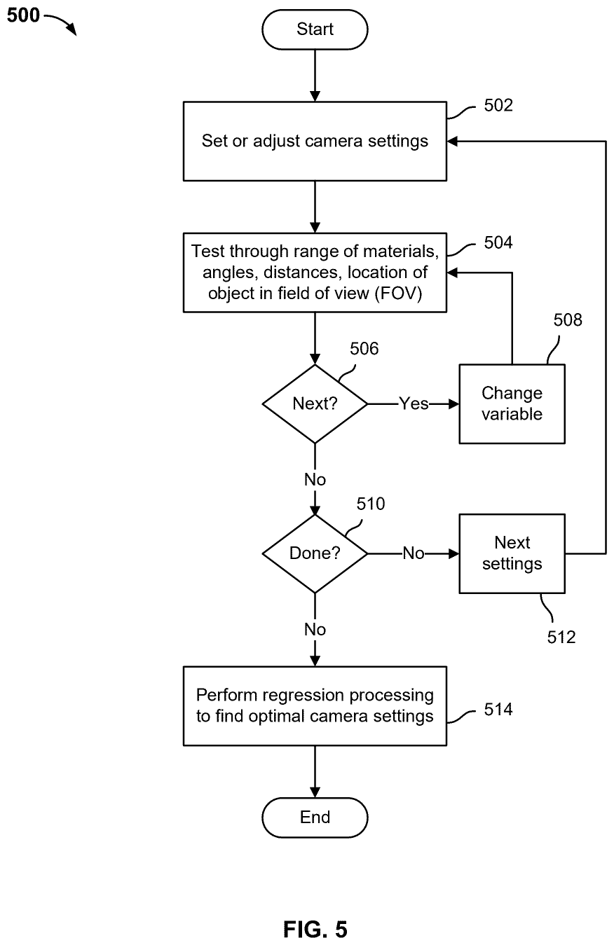

FIG. 5 is a flow diagram illustrating an embodiment of a process to determine optimal settings for a camera for use in connection with a robotic system to perform tasks in a warehouse or other logistics context. In various embodiments, process 500 of FIG. 5 may be performed to determine optimal settings and/or parameters to use on or in connection with a camera that is being characterized. In some embodiments, process 500 may be used to perform the characterization procedure described above under the heading “Camera Design of Experiments”. In the example shown, at 502 camera and/or image processing algorithm settings and/or parameters are set to initial settings or the next settings to be tested, e.g., according to a characterization procedure. At 504, the camera is operated at the current settings with a range of target object materials, angles, distances, location with FOV, etc., for example as specified in a characterization procedure. For each, the difference between a plane fit as determined using images from the camera and the current settings and algorithm parameters is stored. Successive iterations are performed, according to the procedure, until all have been completed, 506, 508. If further combinations of settings/parameters remain to be characterized, 510, 512, a set of iterations of the above characterization steps 502, 504, 506, 508 are performed for each set of settings/parameters 510, 512 specified in the characterization procedure. At 514, regression processing is performed to determine optimal camera settings and image processing algorithm parameters.

In various embodiments, different camera settings and/or image processing algorithm parameters may be determined for different environments and/or objects to be handled. In some embodiments, a robotic system as disclosed herein may look up the camera settings and/or image processing parameters to be used for a given camera and/or other attributes, which may be determined automatically, e.g., based on image data and/or input by an operator, and the system may automatically set the camera settings and/or image processing parameters accordingly.

In various embodiments, a framework and system to test and characterize 3D cameras used in warehouse logistics automation, as disclosed herein, provides quantitative benchmarks and characterization methods to evaluate and configure RGB-D cameras, ensuring optimal performance in specific applications, addressing the need for standardized evaluation methods, facilitating improved system performance and algorithm development.

In various embodiments, ground truth established using high end cameras and/or vision systems, combined with techniques disclosed herein, may enable lower cost cameras to be used reliable by robotic systems to perform logistics applications, such as picking and placing items in a warehouse of other logistics setting, e.g., to perform tasks such as palletization/depalletization, sortation/singulation, kitting, truck or container loading/unloading, etc.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a communication interface configured to receive image data generated by a camera; and
a processor coupled to the communication interface and configured to:
use a first set of image data to perform camera sensor testing to generate a set of base capabilities for the camera;
perform camera characterization processing with respect to the camera, based at least in part on the set of base capabilities; and
determine, based at least in part on the camera characterization processing, one or more of the following: one or more optimal camera settings; an optimal camera placement; and an optimal image processing algorithm parameter.

2. The system of claim 1, further comprising a memory configured to store data comprising results of said camera sensor testing and camera characterization processing.

3. The system of claim 1, wherein the camera sensor testing is performed according to a test procedure.

4. The system of claim 3, wherein the test procedure includes a plurality of individual tests.

5. The system of claim 1, wherein the camera sensor testing includes one or more tests performed in a prescribed test setting set up according to a test procedure.

6. The system of claim 1, wherein the camera characterization processing includes comparing a set of results generated based on image data from the camera with a corresponding ground truth.

7. The system of claim 1, wherein the camera characterization processing includes performing a plane fitting characterization.

8. The system of claim 1, wherein the optimal image processing algorithm parameter is determined at least in part by iterating through a set of candidate image processing algorithm parameters and for each candidate comparing an associated image processing result with a corresponding ground truth.

9. The system of claim 8, wherein determining the optimal image processing algorithm parameter includes iterating through a set of characterization set up variables with respect to each candidate value for the image processing algorithm parameter.

10. The system of claim 9, wherein determining the optimal image processing algorithm parameter includes performing regression processing with respect to respective characterization results determined for the set of candidate image processing algorithm parameters.

11. The system of claim 1, wherein the processor is further configured to detect that the camera has been integrated into a robotic system and set the image processing algorithm parameter to the optimal value for the camera in response to detect that the camera has been integrated into the robotic system.

12. The system of claim 11, wherein the robotic system is configured to perform a specific robotic application and the processor is configured to set the image processing algorithm parameter to a value associated specifically with the specific robotic application.

13. The system of claim 1, wherein the image processing algorithm parameter is associated with a random sample consensus (RANSAC) algorithm.

14. The system of claim 1, wherein the camera characterization processing includes positioning in a test space an object of known dimensions, the object comprising a box having one or more planar surfaces, determining ground truth transformation matrices, selecting as a region of interest a selected planar surface of the box in the camera frame, performing plane fitting, and comparing a result of the plane fitting to a corresponding ground truth.

15. The system of claim 1, wherein one or more of the following are automated: placement of the camera, place of a target, performance of the camera sensor testing, performance of the camera characterization processing, and determining one or more of the one or more optimal camera settings; an optimal camera placement; and an optimal image processing algorithm parameter.

16. A method, comprising:
receiving via a communication interface image data generated by a camera;
use a first set of image data to perform camera sensor testing to generate a set of base capabilities for the camera;
perform camera characterization processing with respect to the camera, based at least in part on the set of base capabilities; and
determine, based at least in part on the camera characterization processing, one or more of the following: one or more optimal camera settings; an optimal camera placement; and an optimal image processing algorithm parameter.

17. The method of claim 15, wherein the camera characterization processing includes comparing a set of results generated based on image data from the camera with a corresponding ground truth.

18. The method of claim 15, wherein the optimal image processing algorithm parameter is determined at least in part by iterating through a set of candidate image processing algorithm parameters and for each candidate comparing an associated image processing result with a corresponding ground truth.

19. The method of claim 15, further comprising detecting that the camera has been integrated into a robotic system and setting the image processing algorithm parameter to the optimal value for the camera in response to detecting that the camera has been integrated into the robotic system.

20. A computer program product embodied in a non-transitory computer readable medium and comprising computer instructions for:
receiving via a communication interface image data generated by a camera;
use a first set of image data to perform camera sensor testing to generate a set of base capabilities for the camera;
perform camera characterization processing with respect to the camera, based at least in part on the set of base capabilities; and
determine, based at least in part on the camera characterization processing, one or more of the following: one or more optimal camera settings; an optimal camera placement; and an optimal image processing algorithm parameter.
